(19) United States
(12) Patent Application Publication
(10) Pub. No.: US 2020/0353385 A1
(43) Pub. Date: Nov. 12, 2020

(54) FILTER APPARATUS

(71) Applicant: DING CHENG INTERNATIONAL CO., LTD., Taichung City (TW)

(72) Inventors: Fang-Pi CHANG, Tainan City (TW); Jung-Ming WU, New Taipei City (TW); Cheng-Yang HSU, New Taipei City (TW)

(21) Appl. No.: 16/789,399

(22) Filed: Feb. 12, 2020

(30) Foreign Application Priority Data
May 10, 2019 (TW) 108116285

(51) Int. Cl. B01D 29/90; B01D 29/33; B01D 29/00

(52) U.S. Cl. CPC B01D 29/908; B01D 29/33; B01D 2201/32; B01D 2201/302; B01D 29/0059

(57) ABSTRACT

A filter apparatus includes a filter unit and a conveying unit. The filter unit is configured to filter a liquid to-be-filtered, and the liquid to-be-filtered enters the filter unit in a first tangent-line direction of the filter unit. The conveying unit extracts a liquid to-be-conveyed from a periphery of the filter unit to output a conveyed liquid, and the conveyed liquid enters the filter unit in a second tangent-line direction of the filter unit.

### CROSS-REFERENCE TO RELATED APPLICATION

This application claims priority to Taiwan Application Serial Number 108116285, filed May 10, 2019, which is herein incorporated by reference in its entirety.

### BACKGROUND

### Field of Invention

The embodiments of the present disclosure relate to a filter apparatus, and more particularly, to a filter apparatus with a speed-controllable spiral flow field.

### Description of Related Art

Filter materials are commonly used in the industry to filter liquids to obtain desired filtrates, in which the filter materials have different porosities to filter particles of different sizes.

A traditional filtration method is to let liquid pass through a filter material, and use inner and outer filter cores with different porosities to grasp large-sized particles and let desired small-sized particles or clean liquid pass, to achieve a filtration effect. A direction of a feed flow and a direction of a filtrate flow are both approximately a radial direction of the filter material, such that a portion of large-sized particles will be caught in the outer layer of the filter material, but another portion of large-sized particles will flow towards the inner layer of the filter material due to a feed pressure. Thus, it is easy to push the large-sized particles into an interior of the filter material due to the pressure difference caused by clogging of small pores in the inner layer of the filter material, and then the large-sized particles flow out together with the clean filtrate or the filtrate containing the desired small-sized particles, resulting in a decrease in a life cycle of the filter material or inefficient filtration.

Therefore, there is a need to provide a filter apparatus that can increase filtration efficiency and extend the life cycle of the filter material.

### SUMMARY

An object of the disclosure is to provide a filter apparatus that can increase filtration efficiency and extend a life cycle of the filter material.

According to the object of the present disclosure, a filter apparatus is provided, which includes a filter unit and a conveying unit. The filter unit is configured to filter a liquid to-be-filtered, and the liquid to-be-filtered enters the filter unit in a first tangent-line direction of the filter unit. The conveying unit extracts a liquid to-be-conveyed from a periphery of the filter unit to output a conveyed liquid, and the conveyed liquid enters the filter unit in a second tangent-line direction of the filter unit.

In some embodiments, the first tangent-line direction and/or the second tangent-line direction include a direction deflected from a tangential direction corresponding to the first tangent-line direction or the second tangent-line direction with an angular range, and the angular range is ±20 degrees.

In some embodiments, the liquid to-be-filtered enters the filter unit further in a third tangent-line direction.

In some embodiments, the conveyed liquid enters the filter unit further in a fourth tangent-line direction.

In some embodiments, the liquid to-be-filtered enters the filter unit via a first position of the filter unit, and the conveyed liquid enters the filter unit via a second position of the filter unit, in which the first position is disposed diagonally with the second position.

In some embodiments, the conveying unit controls a flow rate of the conveyed liquid based on a flow rate of the liquid to-be-conveyed.

In some embodiments, the conveying unit controls the flow rate of the conveyed liquid based on a pressure of the liquid to-be-conveyed.

In some embodiments, the conveying unit controls the flow rate of the conveyed liquid based on particle parameter(s) of the liquid to-be-conveyed.

In some embodiments, a flow rate of the liquid to-be-filtered entering the filter unit match with the flow rate of the conveyed liquid.

In some embodiments, the filter apparatus further includes a casing, the filter unit is disposed in the casing, the casing includes an input portion and a return portion, the liquid to-be-filtered enters the filter unit through the input portion, and the conveyed liquid enters the filter unit through the return portion.

In order to make the above features and advantages of the present disclosure more apparent, the following embodiments are described in detail with reference to the accompanying drawings.

### BRIEF DESCRIPTION OF THE DRAWINGS

Aspects of the disclosure are better understood from the following detailed description when read with the accompanying figures. To be noted, in accordance with the standard practice in the industry, various features are not drawn to scale. In fact, the dimensions of the various features can be arbitrarily increased or decreased for clarity of discussion.

FIG. 1 is a schematic top view showing a filter unit of a filter apparatus according to an embodiment of the present disclosure and liquid flow directions.

FIG. 2 is a schematic cross-sectional view of the filter unit of the filter apparatus of FIG. 1, which also shows liquid flow directions and a conveying unit.

FIG. 3A to FIG. 3C are schematic diagrams of ranges substantially covered by a first tangent-line direction according to different embodiments of the present disclosure.

FIG. 4A to FIG. 4C are block diagrams of a conveying unit according to different embodiments of the present disclosure.

FIG. 5 is a schematic perspective view of a filter apparatus according to an embodiment of the present disclosure.

FIG. 6 is a schematic top view of a filter apparatus according to an embodiment of the present disclosure.

FIG. 7 is a schematic cross-sectional view of a filter apparatus according to an embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. In addition, the terms “first”, “second”, and the like, as used herein, are not intended to mean a sequence or order, and are merely used to distinguish elements or operations described in the same technical terms.

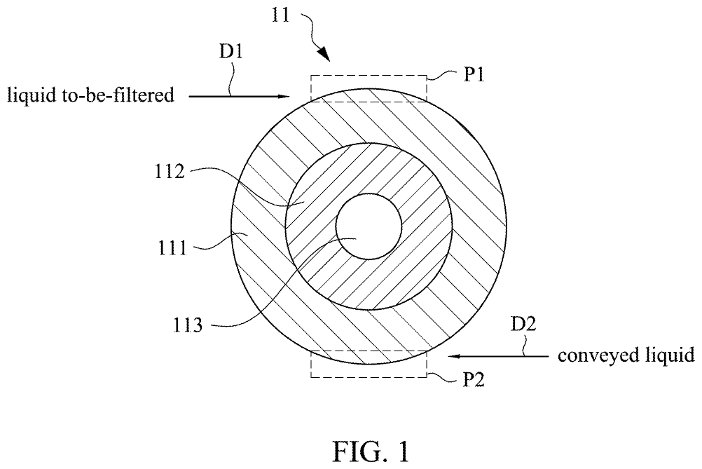

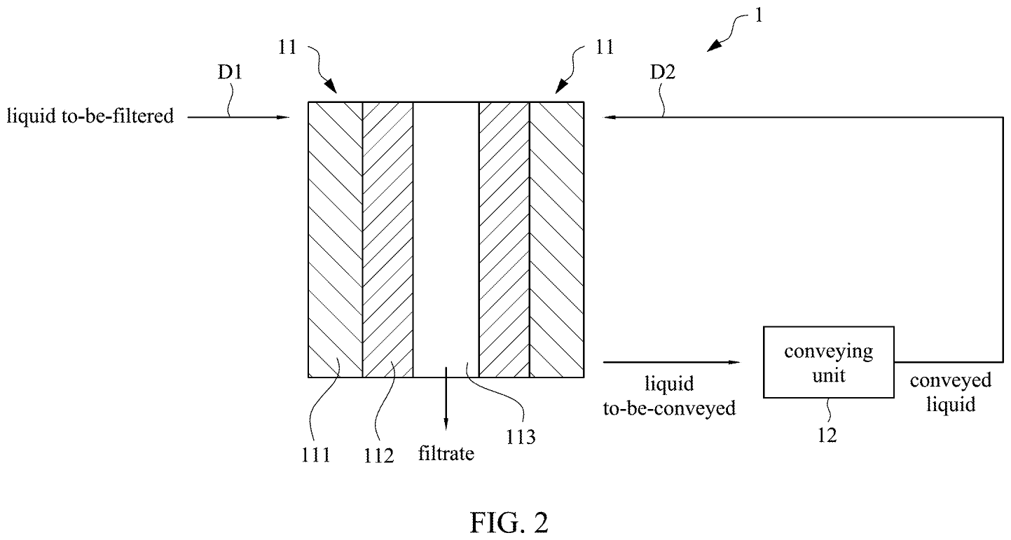

Referring to FIG. 1 and FIG. 2, in which FIG. 1 is a schematic top view showing a filter unit 11 of a filter apparatus 1 according to an embodiment of the present disclosure and liquid flow directions, and FIG. 2 is a schematic cross-sectional view of the filter unit 11 of the filter apparatus 1 of FIG. 1, which also shows liquid flow directions and a conveying unit 12. In this embodiment, the filter apparatus 1 includes the filter unit 11 and the conveying unit 12.

Referring to FIG. 1 and FIG. 2, the filter unit 11 is configured to filter a liquid to-be-filtered, and the liquid to-be-filtered enters the filter unit 11 in a first tangent-line direction D1 of the filter unit 11. In the embodiment, the filter unit 11 is exemplified by a two-layered filter core, the filter unit 11 includes an outer-layer filter core 111 and an inner-layer filter core 112 located within the outer-layer filter core 111, and the two cores are concentrically arranged and connected to each other. Moreover, in general, a porosity of the outer-layer filter core 111 is greater than that of the inner-layer filter core 112, such that the outer-layer filter core 111 can filter particles of larger sizes and the inner-layer filter core 112 can filter particles of smaller sizes. The filtrate (filtered liquid) produced by the filter unit 11 can have smaller particles or almost no particle, which can depend on a desired application. The filter unit 11 further includes a hollow portion 113 located inside the inner-layer filter core 112, and the filtrate can flow out from a top end or a bottom end of the hollow portion 113. Herein, the filtrate flows out from the bottom end of the hollow portion 113 as an example.

How the liquid to-be-filtered enters the filter unit 11 is not limited herein, and the liquid to-be-filtered may be, for example, guided by a casing or a hose, or pressure delivered by a pressure motor, and the like. In the embodiment, the liquid to-be-filtered enters the filter unit 11 in the first tangent-line direction D1. The definition of the first tangent-line direction D1 will be described below. The liquid to-be-filtered enters the filter unit 11 via a first position P1 of the filter unit 11, and the first tangent-line direction D1 is related to the first position P1 of the filter unit 11. In other words, after the first position P1 is selected, the first tangent-line direction D1 is determined to be a tangent-line direction of the first position P1. Herein, according to the industry practice, the first position P1 does not refer to one single point, but refers to a range, and for example, the range is defined as that the range has a width or length smaller than or equal to ½ of a radius of the filter unit 11.

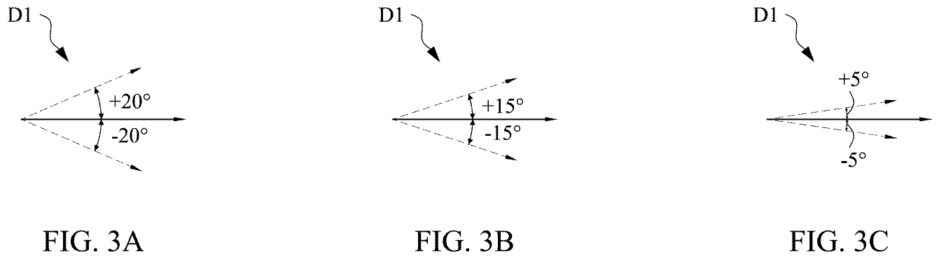

In addition, due to the above definition of the first position P1, manufacturing errors or other reasons, the first tangent-line direction D1 of the embodiment is not specifically directed to the tangential direction of the first position P1, but substantially may have some margin in three-axis directions (X-axis, Y-axis, and Z-axis). The tangential direction herein is, for example, a direction perpendicular to a line connecting a center point of the first position P1 to a center of the filter unit 11. For example, in an embodiment of the present disclosure, the first tangent-line direction D1 substantially includes a direction deflected from the tangential direction corresponding to the first tangent-line direction with an angular range, and the angular range may be ±20 degrees (as shown in FIG. 3A). In another embodiment of the present disclosure, the angular range may be ±15 degrees (as shown in FIG. 3B). In further another embodiment of the present disclosure, the angular range may be ±5 degrees (FIG. 3C). When the first tangent-line direction D1 is within the above ranges, the advantages of the present disclosure can be achieved to some extent.

In addition, as shown in FIG. 2, the liquid to-be-filtered enters the filter unit 11 from a top of the filter unit 11 in the first tangent-line direction D1, but the present disclosure is not limited thereto, and the liquid to-be-filtered may enter the filter unit 11 from different levels. Moreover, in some applications, such as a large size filter unit or at least three filter core layers, the liquid to-be-filtered may enter the filter unit 11 further in a third tangent-line direction. That is, there are multiple inlets, and the inlets can be at different levels. The third tangent-line direction may have the same definition as the first tangent-line direction D1 described above, and details are not described here again.

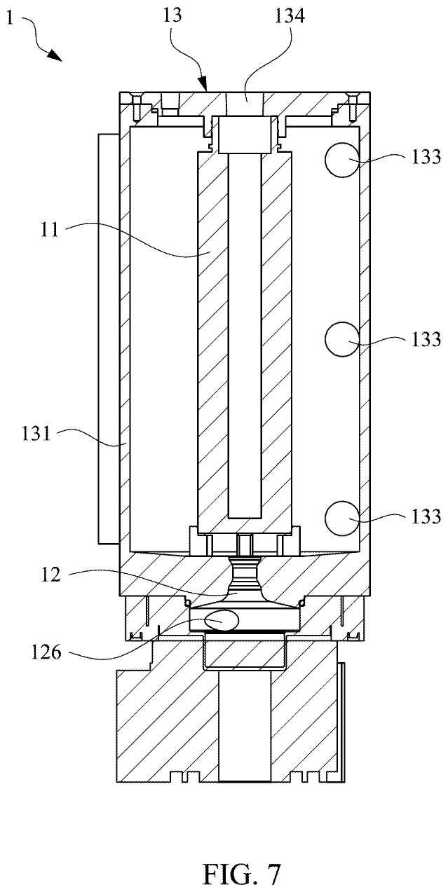

Referring to FIG. 1 and FIG. 2, the conveying unit 12 of the filter apparatus 1 extracts a liquid to-be-conveyed from a periphery of the filter unit 11 to output a conveyed liquid, and the conveyed liquid enters the filter unit 11 in the second tangent-line direction D2 of the filter unit 11. The conveying unit 12 includes, for example, a pump, a pressure motor or the like, and may extract the liquid to-be-conveyed from the periphery of the filter unit 11 and output the conveyed liquid. The periphery includes, for example, a space between the filter unit 11 and a casing 13 (referring to FIG. 7) containing the filter unit 11. In this embodiment, the second tangent-line direction D2 may have the same definition as the first tangent-line direction D1 described above. The conveyed liquid enters the filter unit 11 via the second position P2 of the filter unit 11, and the second tangent-line direction D2 is related to the second position P2 of the filter unit 11. The other details can be referred to the foregoing description, and thus will not be described here again.

In addition, as shown in FIG. 2, the conveyed liquid enters the filter unit 11 from the top of the filter unit 11 in the second tangent-line direction D2, but the present disclosure is not limited thereto, and the conveyed liquid may enter the filter unit 11 from different levels. Moreover, in some applications, such as a large size filter unit or at least three filter core layers, the conveyed liquid may enter the filter unit 11 in a fourth tangent-line direction. That is, there are multiple return ports. The fourth tangent-line direction may be defined the same as the first tangent-line direction D1 described above, and details are not described here again.

Furthermore, as shown in FIG. 1, in the present embodiment, the first position P1 and the second position P2 of the filter unit 11 are arranged diagonally. Of course, the present disclosure is not limited thereto, and the first position P1 and the second position P2 may be arranged otherwise. For example, phase angles of the first position P1 and the second position P2 are different by ±40 degrees.

The conveying unit 12 of the embodiment can control a flow rate of the conveyed liquid as needed or applied, for example, based on the flow rate, pressure or particle parameter of the liquid to-be-conveyed. Some embodied aspects are exemplified for illustration.

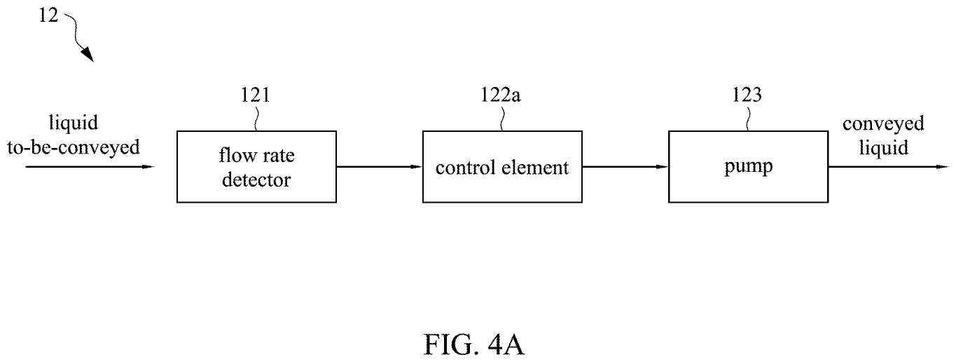

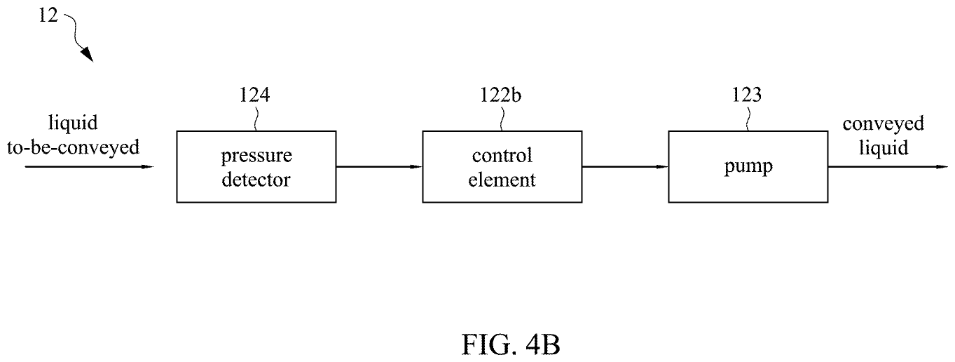

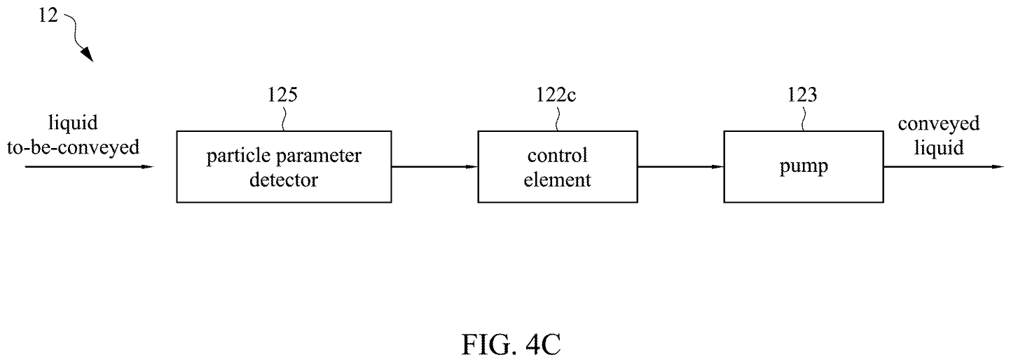

As shown in FIG. 4A, the conveying unit 12 includes a flow rate detector 121, a control element 122a, and a pump 123, and the control element 122a is electrically connected to the flow rate detector 121 and the pump 123. The flow rate detector 121 is configured to detect a flow rate of the liquid to-be-conveyed, and the control element 122a controls a flow rate of the conveyed liquid outputted by the pump 123 based on the detected flow rate.

As shown in FIG. 4B, the conveying unit 12 includes a pressure detector 124, a control element 122b, and a pump 123, and the control element 122b is electrically connected to the pressure detector 124 and the pump 123. The pressure detector 124 is configured to detect a pressure of the liquid to-be-conveyed, and the control element 122b controls a flow rate of the conveyed liquid outputted by the pump 123 based on the detected pressure.

As shown in FIG. 4C, the conveying unit 12 includes a particle parameter detector 125, a control element 122c, and a pump 123, and the control element 122c is electrically connected to the particle parameter detector 125 and the pump 123. The particle parameter detector 125 is configured to detect parameters of the liquid to-be-conveyed, such as a number, a ratio, or other particle-related parameters of the particles with a particle size greater than 1 micron. The control element 122c controls a flow rate of the conveyed liquid outputted by the pump 123 based on the detected particle parameters.

Additionally, in some applications, the conveying unit 12 may be configured to match the flow rate of the conveyed liquid and the flow rate of the liquid to-be-filtered entering the filter unit. For example, in one mode, when the flow rate of the liquid to-be-filtered entering the filter unit is too slow, the conveying unit 12 can increase the flow rate of the conveyed liquid; and in another mode, when the flow rate of the liquid to-be-filtered entering the filter unit increases, the conveying unit 12 can correspondingly increase the flow rate of the conveyed liquid. Moreover, in some applications, the conveying unit 12 may provide a cleaning mode. For example, when the detected flow rate of the liquid to-be-filtered or the liquid to-be-conveyed is too slow, this represents the filter unit 11 has a blockage situation, and the conveying unit 12 can thus increase the flow rate of the conveyed liquid for a period of time to form a high-speed spiral flow field to clean the filter unit 11 and eliminate a back pressure condition. In addition to the above situations, the high-speed spiral flow field may be applied to other situations while needed. Furthermore, in a mode, when the flow rate of the liquid to-be-conveyed is decreased, the flow rate of the liquid to-be-filtered entering the filter unit 11 and the flow rate of the conveyed liquid can be simultaneously increased.

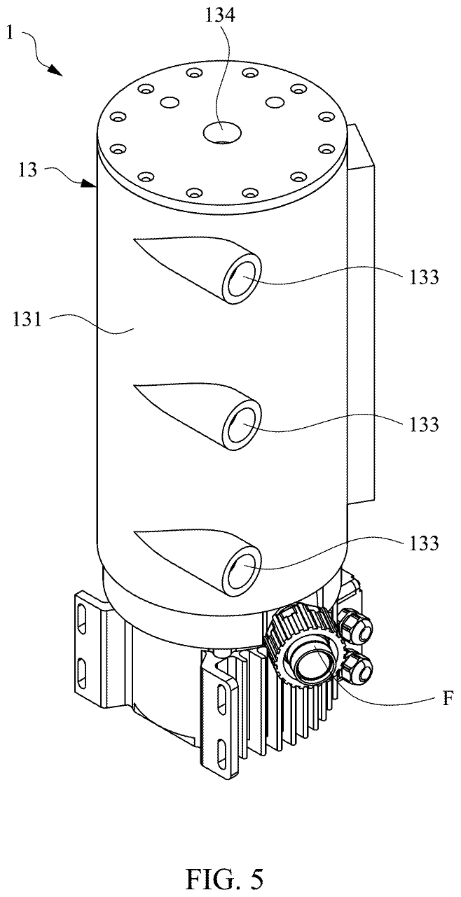

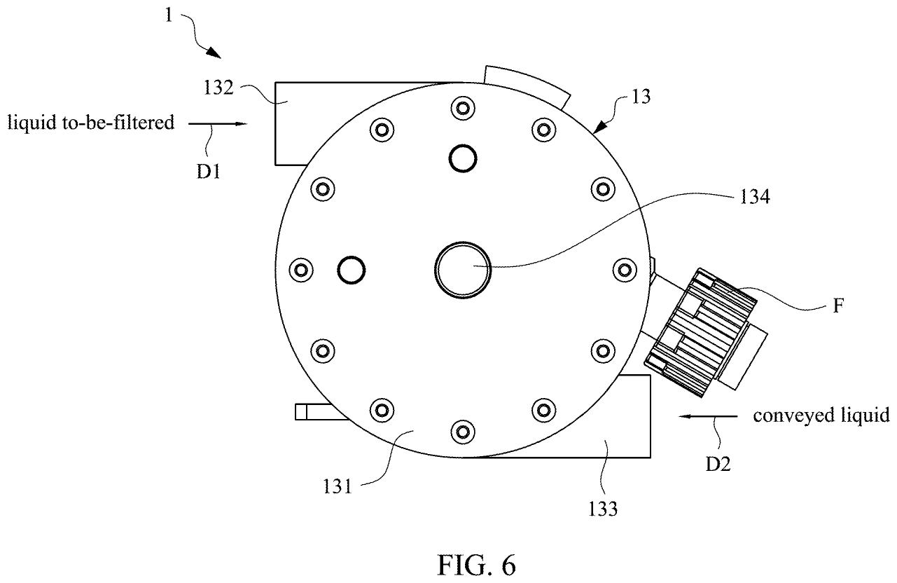

FIG. 5 is a schematic perspective view of the filter apparatus 1 according to an embodiment of the present disclosure, FIG. 6 is a schematic top view of the filter apparatus 1 according to an embodiment of the present disclosure, and FIG. 7 is a schematic cross-sectional view of the filter apparatus 1 according to an embodiment of the present disclosure. As shown in FIG. 7, the filter apparatus 1 includes the filter unit 11, the conveying unit 12, and a casing 13. The filter unit 11 and the conveying unit 12 have been described above in detail, and will not be described here.

As shown in FIG. 6, the casing 13 includes a casing portion 131, one or more input portions 132, one or more return portions 133, and an output portion 134. As shown in FIG. 7, the casing portion 131 is hollow, and the filter unit 11 is disposed in the casing portion 131.

Referring to FIG. 6 and FIG. 7 simultaneously, the input portion 132 is disposed on the casing portion 131 and may be integrally formed with the casing portion 131, for example. The liquid to-be-filtered enters the filter unit 11 in the first tangent-line direction D1 via the input portion 132. At least one portion of the input portion 132, which is adjacent to the filter unit 11 or the casing portion 131, extends along the first tangent-line direction D1 to enter the liquid to-be-filtered to the filter unit 11 along the first tangent-line direction D1.

Referring to FIG.6 and FIG. 7 continuously, the return portion 133 is disposed on the casing portion 131 and may be integrally formed with the casing portion 131, for example. The conveyed liquid enters the filter unit 11 in the second tangent-line direction D2 via the return portion 133. At least one portion of the return portion 133, which is adjacent to the filter unit 11 or the casing portion 131, extends in the second tangent-line direction D2 to enter the conveyed liquid to the filter unit 11 in the second tangent-line direction D2. Although FIG. 5 and FIG. 7 show three return portions 133, it is not necessary to use the three return portions 133 at the same time in practice, but it is applicable as needed. In addition, FIG. 5 and FIG. 7 show that the three return portions 133 are arranged in a row, but they may have another positional arrangement, such as a staggered arrangement.

As shown in FIG. 5 and FIG. 7, the output portion 134 is disposed on a top side of the casing portion 131. Herein, the output portion 134 is exemplified by an opening of the casing portion 131.

In the embodiment, as shown in FIG. 7, the conveying unit 12 is connected to a portion of the casing 13. Herein, the conveying unit 12 is located under the filter unit 11 and connected to the casing portion 131 as an example. This allows the conveying unit 12 to draw the liquid to-be-conveyed directly from the periphery of the filter unit 11, that is, from the space between the casing 13 and the filter unit 11, and to discharge the conveyed liquid from an outlet 126 of the conveying unit 12. A fixing member F communicates with the outlet 126 and may be fixed to a duct (not shown) which is connected to the return portion 133, such that the conveyed liquid can enter the filter unit 11 via the duct and the return portion 133.

The above embodiments are merely illustrative and are not intended to limit the present disclosure. In other embodiments, the casing 13 may have various variations, for example, the input portion 132 and the return portions 133 are not protruded from the casing 13 but formed by the openings of the casing portion 131 and delivery ducts. Alternatively, in another embodiment, the conveying unit 12 is disposed outside the casing 13 and connected to the casing 13 by one or more ducts, such that a size of the casing 13 is reduced.

In summary, the present disclosure provides a filter apparatus that enters the liquid to-be-filtered to the filter unit in the first tangent-line direction of the filter unit, and enters the conveyed liquid outputted by the conveying unit to the filter unit in the second tangent-line direction of the filter unit, thereby forming a spiral flow field. This spiral flow field may be controlled by the conveying unit to reach a high speed spiral flow field. Therefore, the present disclosure can greatly reduce probability that large size particles block the inner-layer filter core, thereby enhancing a filtration effect and extending a life cycle of the filter unit.

In addition, the flow rate of the conveyed liquid is not affected by porosity of the filter unit, and is controlled by the conveying unit, such that a high-speed and effective spiral flow field is provided, thereby expanding a scope of application and enhancing product competitiveness. For example, the filter apparatus of the present disclosure may be applied to a large size filter unit, a filter unit with a multi-layered filter core, or a specific operation mode that may be performed by a high-speed spiral flow field.

The features of several embodiments are outlined above, so those skilled in the art can understand the aspects of the present disclosure. Those skilled in the art will appreciate that the present disclosure can be readily utilized as a basis for designing or modifying other processes and structures, thereby achieving the same objectives and/or achieving the same advantages as the embodiments described herein. Those skilled in the art should also understand that these equivalent constructions do not depart from the spirit and scope of the present disclosure, and they can make various changes, substitutions and alterations without departing from the spirit and scope of this disclosure.

What is claimed is:

1. A filter apparatus, comprising:
a filter unit configured to filter a liquid to-be-filtered, and the liquid to-be-filtered entering the filter unit in a first tangent-line direction of the filter unit; and
a conveying unit extracting a liquid to-be-conveyed from a periphery of the filter unit to output a conveyed liquid, the conveyed liquid entering the filter unit in a second tangent-line direction of the filter unit.

2. The filter apparatus of claim 1, wherein the first tangent-line direction and/or the second tangent-line direction include a direction deflected from a tangential direction corresponding to the first tangent-line direction or the second tangent-line direction with an angular range, and the angular range is ±20 degrees.

3. The filter apparatus of claim 1, wherein the liquid to-be-filtered enters the filter unit further in a third tangent-line direction.

4. The filter apparatus of claim 1, wherein the conveyed liquid enters the filter unit further in a fourth tangent-line direction.

5. The filter apparatus of claim 1, wherein the liquid to-be-filtered enters the filter unit via a first position of the filter unit, and the conveyed liquid enters the filter unit via a second position of the filter unit, wherein the first position is disposed diagonally with the second position.

6. The filter apparatus of claim 1, wherein the conveying unit controls a flow rate of the conveyed liquid based on a flow rate of the liquid to-be-conveyed.

7. The filter apparatus of claim 1, wherein the conveying unit controls a flow rate of the conveyed liquid based on a pressure of the liquid to-be-conveyed.

8. The filter apparatus of claim 1, wherein the conveying unit controls a flow rate of the conveyed liquid based on a particle parameter of the liquid to-be-conveyed.

9. The filter apparatus of claim 1, wherein a flow rate of the liquid to-be-filtered entering the filter unit match with a flow rate of the conveyed liquid.

10. The filter apparatus of claim 1, further comprising:
a casing, the filter unit being disposed in the casing, and the casing comprising an input portion and a return portion, wherein the liquid to-be-filtered enters the filter unit through the input portion, and the conveyed liquid enters the filter unit through the return portion.
